(19) United States
(12) Patent Application Publication
(10) Pub. No.: US 2012/0279212 A1
(43) Pub. Date: Nov. 8, 2012

(54) CONTROL ARRANGEMENT

(75) Inventors: Christian Fagerlund, Bredared (SE); Jonathan Tresadern, Swindon (GB)

(73) Assignee: ULTRONICS LIMITED, CHELTENHAM (GB)

(21) Appl. No.: 13/386,235

(22) PCT Filed: Jul. 2, 2010
(86) PCT No.: PCT/EP10/59476

§ 371 Date: Jul. 26, 2012

(30) Foreign Application Priority Data
Jul. 20, 2009 (GB) 0912549.3

(51) Int. Cl. F15B 13/04; F15B 21/08

(52) U.S. Cl. 60/462

(57) ABSTRACT

A control arrangement for use in a hydraulic control system including a control valve having at least two movable elements. The control arrangement is configured to control the positions of the two movable elements such that fluid from a common fluid pressure source is applied to both of the control surfaces of an actuator to drive the actuator. In an embodiment, the control surfaces have different effective areas.

This invention relates to a control arrangement, and in particular to a method of controlling the operation of a control valve of the type having two movable or slidable elements (referred to hereafter as a twin spool control valve) to permit high speed movement of an actuator associated therewith.

Hydraulic control systems are in widespread use in controlling the operation of excavating equipment, hoists, lifting arms and a number of similar devices. The control systems used therein typically include control valves in the form of a spool slidable within a bore, the position of the spool determining which of a pair of outlet ports is connected to relatively high pressure fluid and which is connected to a low pressure at any given time.

More recently, twin spool control valves have been used. Such arrangements have several advantages over single spool arrangements as the positions occupied by the two spools can be controlled individually. However, the control schemes typically used to drive such control valves are very similar to those that have been used successfully in relation to the single spool arrangements.

It is an object of the invention to provide a control arrangement for such a control valve which permits enhanced performance of a device controlled using the control valve.

According to the present invention there is provided a control arrangement for use in a hydraulic control system including a control valve of the type having at least two movable elements, comprising the step of:

controlling the positions of the two movable elements such that fluid from a common fluid pressure source is applied to both of the control surfaces of an actuator, the control surfaces being of different effective areas, to drive the actuator for movement.

The mode of operation outlined above is advantageous in that the actuator can be moved relatively quickly when lightly loaded, the net quantity of fluid that must be applied to the actuator to achieve the movement being relatively low, fluid returning from the actuator being returned to the supply line. As the net fluid demand is relatively low, it can be met quickly by the associated pump.

A second mode of operation in which dissimilar pressures are applied to the actuator is also present, such an operating mode permitting positive driving of the actuator in two directions, usually at a slower speed of movement. The forces that can be generated by the actuator when operated in this mode are higher than can be achieved when operating in accordance with the first mode of operation.

The control arrangement is conveniently switchable between these operating modes, as desired.

When operating in accordance with the first mode of operation it will be appreciated that efficiency savings can sometimes be made, as the required pump output is reduced. Often, however, rather than reduce pump output, higher speed actuation will be achieved. Further, as the returning fluid only needs to be passed back to the control valve rather than back to, for example, a tank and pump, energy losses in the system may be reduced.

Preferably, the control valve is operable using data representative of the pressures applied to the actuator and/or the position of the movable elements of the control valve to permit control in a closed loop manner.

This invention will further be described, by way of example, with reference to the accompanying drawings, in which:

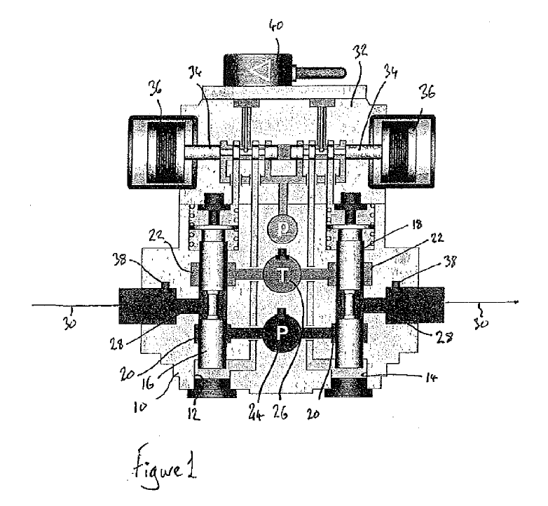

FIG. 1 is a diagrammatic view of a control system incorporating a twin spool control valve; and

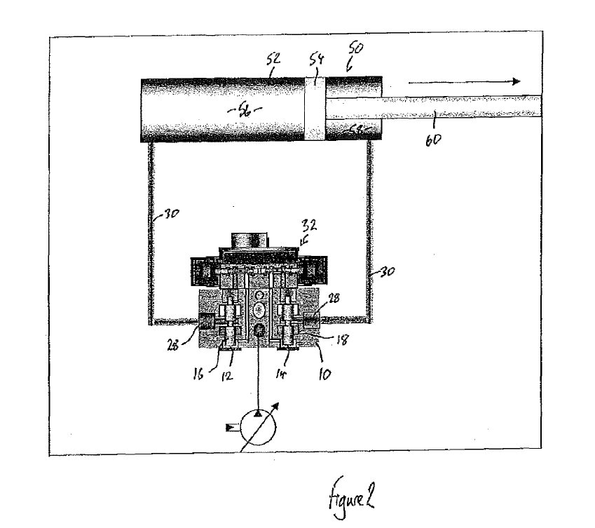

FIG. 2 is a diagram illustrating the system in use.

Referring to FIG. 1 there is illustrated, diagrammatically, a twin spool control valve for use in controlling the operation of the control system of a piece of equipment, for example an excavator, crane, hoist, or the like, at least some functions of which are controlled hydraulically. The control valve comprises a main valve block 10 in which valve bores 12, 14 are formed. Each bore 12, 14 houses a respective spool 16, 18 (forming the twin spools of the control valve). Connected to the main valve block 10, in use, are supply and return pressure lines which are each connected to respective ports 20, 22 opening into the bores 12, 14 via supply and return pressure lines 24, 26. Each of the bores 12, 14 further include or has associated therewith a control port 28, and it will be appreciated that the position of each spool 16, 18 within its associated bore 12, 14 determines whether each of the control ports 28 communicates with the associated supply port 20 or the associated return port 22. From the position illustrated in FIG. 1, if the left hand spool 16 were moved to a raised position the spool 16 would close the supply port 20, communication being permitted in a relatively unrestricted manner between the control port 28 and the return port 22. In contrast, lowering of the right hand spool 18 results in the return port 22 being closed by the spool 18, communication being permitted between the supply port 20 and the control port 28. It will be appreciated that movement of the spools 16, 18 in the opposite directions reverses the connections.

If the main valve block 10 were mounted upon, say, a hoist, the pressures in the control lines 30 connected to the control ports 28 may be used in controlling the position of the lifting arm of the hoist. For example, the movement of the spools 16, 18 to the positions mentioned above may result in raising of the arm due to fluid at supply pressure being supplied via the bore 14 to one end of a piston used in controlling the position of the arm, fluid from the opposite end of the piston being able to flow to return via the other bore 12. Downward movement of the spool 16 and upward movement of the spool 18 will switch the piston connections, resulting in the arm being lowered.

The positions occupied by the spools 16, 18 are controlled by a pilot valve block 32 which controls the volume, and hence pressure, of fluid applied to the opposite ends of the spools 16, 18. The pilot valve block 32 contains a pair of control spools 34, the positions of which are controlled electromagnetically by controlling the current applied to a winding carried by each control spool 34, interaction between the resulting magnetic field and the magnetic field of an associated permanent magnet 36 being used to drive each control spool 34 for movement to desired positions. A control unit 40 is operable to control the current applied to each winding, and hence to control the position occupied by each control spool 34.

Each control spool 34 includes a series of lands which control communication between ports connected to return pressure, an intermediate pilot pressure, and the chambers at each end of each of the spools 16, 18.

From the position illustrated, movement of the left hand control spool 34 to a left hand position results in return pressure being applied to the upper end of the left hand spool 16, pilot pressure being applied to the lower end thereof with the result that the spool 16 occupies its raised position. If this control spool 34 were moved to the right in the orientation illustrated, then the lower end of the spool 16 would be exposed to return pressure whilst the upper end is exposed to pilot pressure, resulting in downward movement of the spool 16. Control over the position occupied by the right hand spool 18 is achieved in a similar manner. It will be appreciated that the positions occupied by the control spools 34 can be controlled independently. Consequently, the positions occupied by the spools 16, 18 can also be controlled independently of one another.

Each control line 30 is connected, to a pressure transducer 38 to permit the feedback to the associated control unit 40, of signals representative of the pressures being applied to the piston, in use. Further, a position transducer conveniently monitors the position of each of the spools 16, 18, the output of the position transducers being supplied to the control unit 40 to permit closed loop control over the spools 16, 18.

In use, an operator uses a control actuator, for example in the form of a joystick, to supply control signals to the control unit 40 indicative of, for example, the required direction and speed of movement of the arm, or of another parameter to be controlled. For example, if he wishes to raise the arm he may pull on the joystick, pushing of the joystick indicating that the arm is to be lowered. Thus, if it is sensed that the operator has pulled on the joystick to indicate that the arm is to be raised, the control unit 40 applies currents to the windings to urge the control spools 34 toward the positions described above, such movement resulting in the spools 16, 18 moving to apply regulated pressures to the piston in an orientation such that the arm is raised. If, instead, the joystick is pushed to indicate that the arm is to be lowered, the positions occupied by the control spools 34 are switched, driving the spools 16, 18 in their alternative directions and resulting in the arm being lowered.

In the description hereinbefore the extreme positions of the spools 16, 18 have been described, i.e. the spool positions in which the supply or return port 20, 22 of each bore 12, 14 is fully open. However, it will be appreciated that the spools 16, 18 will normally be driven to intermediate positions. Further, as the spools 16, 18 are independent of one another and the positions occupied thereby are controllable independently of one another, a range of operating schemes are possible. For example, if the operator moves the joystick by a relatively large angle, the corresponding extreme position of the spools 16, 18 may be achieved to result in a relatively high speed movement of the arm. If the joystick angle is smaller, then the control unit 40 may reduce the degree of opening of, for example, the corresponding return port 22 so as to result in movement of the arm being at a reduced speed.

As shown in FIG. 2, the control valve is used to control the extension and retraction of an actuator 50 comprising a cylinder 52 within which a piston 54 is slidable. The piston 54 and cylinder 52 together define a first chamber 56 which is connected via one of the control lines 30 to the control port 28 associated with the bore 12 and spool 16. The piston 54 and cylinder 52 further define a second chamber 58 which is connected via the other control line 30 to the control port 28 associated with the bore 14 and spool 18.

An output rod 60 is connected to the piston 54, extending through the second chamber 58 and out of the cylinder 52. It will be appreciated that the presence of the rod 60 results in the effective area of the piston 54 exposed to the fluid pressure within the second chamber 58 being significantly smaller than that exposed to the fluid pressure within the first chamber 56. Consequently, if both chambers 56, 58 are supplied with fluid from the same pressure source as occurs in a first operating mode of the control arrangement, the difference in the effective areas over which the fluid pressure acts will result in a force being applied to the piston 54 urging the piston 54 to the right in the orientation illustrated. Provided the applied force is sufficiently large to overcome any externally applied loadings, movement of the piston 54 will occur. If dissimilar pressures are applied as occurs in a second operating mode thereof, then extension or retraction of the actuator will occur depending upon which of the chambers 56, 58 has higher pressure fluid applied thereto.

The control valve controls the pressures applied to the control ports 28, and hence to the chambers 56, 58, as described hereinbefore. Where the control valve operates according to its second mode of operation fluid at high, supply pressure may be applied to the second chamber 58 whilst the first chamber 56 is connected to low, return pressure. As a consequence, the piston 54 moves to the left in the orientation illustrated, fluid flowing from the supply line through the supply port 20 and control valve to the second chamber 58, fluid from the first chamber 56 flowing through the control valve to the return port 22 and from there to a storage tank. Switching of the positions of the spools 16, 18 of the control valve drives the piston 54 to the right in the orientation illustrated.

In accordance with the invention, higher speed operation may be achieved during some operating conditions by controlling the control valve in accordance with a regenerative operating mode (referred to herein as the first mode of operation) in which, rather than relying upon the differential pressure to drive the actuator, in the sense that the chambers 56, 58 are connected to different pressure sources, the differential area thereof is used. In this mode of operation, when it is desired to move the piston 54 to the right in the orientation illustrated, supply pressure is applied to both chambers 56, 58 of the actuator as shown in FIG. 2. The application of fluid pressure from a common pressure source to both chambers 54, 56 results in the desired movement of the actuator, provided the force resulting from the application of the pressure to the differential area is able to overcome any externally applied loading, as a result of the differential effective areas of the piston 54 over which the pressures are applied. The movement of the piston 54 results in fluid being displaced from the second chamber 58. Rather than flowing back to the tank, the fluid flows into the supply line supplementing the output of the pump, thus permitting the pump to be driven at a reduced flow delivery. Alternatively, rather than operate at a reduced flow delivery, the pump output may be maintained at a higher level and the regeneration flow achieved by way of the invention used to achieve an increase in the rate of extension of the actuator.

As this mode of operation can only be used to drive the actuator in one direction, it will be appreciated that unless appropriate external loads are applied to drive the actuator in the opposite direction, the operating mode will need to be switched back to the second mode to achieve actuator movement in the opposite direction.

Closed loop control of the control valve, as outlined hereinbefore, making use of spool position and pressure information, permits the system to be operated efficiently whilst ensuring that operation at desired speeds is achieved. Further, the reductions in the lengths of fluid flow paths achievable by the use of a simple system configuration results in a reduction in energy losses.

The volume of the fluid returned to the supply line during such regenerative flow is reasonably easy to determine, and so calculations of the volume so returned can be used by the control unit in controlling operation of the pump to optimise system efficiency.

As mentioned hereinbefore, the control valve may have other forms of movable or slidable element than the spools mentioned herein, and the invention is equally applicable to such valves.

Regenerative operation of typical single spool control valves is known but typically requires the addition of extra components in the form of valves or pipework to the control system in order to achieve a regenerative flow. For example, regenerative operation of a system including a typical single spool control valve can be achieved by providing a pilot operated check valve which can open to allow fluid flow from one side of the piston to the other when regenerative movement is to take place, or by providing, for example, a solenoid operated valve to perform this function and also allow user control over whether or not regeneration occurs. Other arrangements require one end of the piston to be permanently connected to high pressure, even when not in use, but this is undesirable and may be unsuitable for use in some applications.

In contrast, the arrangement of the present invention achieves regeneration simply by appropriately controlling the manner in which the control valve is operated, without requiring the provision of extra valves and pipes or the like. As a result, regeneration can be achieved in a simple, convenient manner without incurring significant additional costs and without requiring the provision of extra parts and the servicing, etc, thereof.

A number of other modifications and alterations may be made to the arrangements described hereinbefore without departing from the scope of the invention.

What is claimed is:

1.-5. (canceled)

6. A control arrangement for use in a hydraulic control system, the control arrangement comprising:
a control valve having at least two movable elements;
wherein the control valve is configured to control the positions of the at least two movable elements such that fluid from a common fluid pressure source is applied to both of the control surfaces of an actuator, the control surfaces being of different effective areas, to drive the actuator for movement.

7. The control arrangement of claim 6, wherein the control arrangement is switchable to a second mode of operation in which dissimilar pressures are applied to the actuator.

8. The control arrangement of claim 6, wherein the control valve is operable using data representative of the pressures applied to the actuator to permit control in a closed loop manner.

9. The control arrangement of claim 6, wherein the control valve is operable using data representative of the pressures applied to the position of the movable elements of the control valve to permit control in a closed loop manner.

10. The control arrangement of claim 6, wherein the control valve is operable using data representative of the pressures applied to the actuator and the position of the movable elements of the control valve to permit control in a closed loop manner.

11. The control arrangement of claim 6, including a pump configured to provide an operating flow delivery.

12. The control arrangement of claim 11, wherein the operating flow delivery is controlled according to the operating mode.

13. A hydraulic control system, the system comprising:
a control valve having at least two movable elements; and
a control unit controlling the positions of the movable elements, the control unit controlling the positions of the at least two movable elements such that fluid from a common fluid pressure source is applied to two control surfaces of an actuator, the control surfaces being of different effective areas, to drive the actuator for movement.

14. A hydraulic control system, the system comprising:
a control valve having at least two movable elements;
a control unit configured to control the positions of the movable elements; and
an actuator having two control surfaces, the control surfaces having different effective areas;
wherein the control unit is configured to control the positions of the at least two movable elements such that fluid from a common fluid pressure source is applied to the two control surfaces of the actuator to drive the actuator for movement.
